(19) United States
(12) Patent Application Publication
(10) Pub. No.: US 2026/0126463 A1
(43) Pub. Date: May 7, 2026

(54) BIOPROCESSING SYSTEM AND METHODS OF USE

(71) Applicants: Nalge Nunc International Corporation, Rochester, NY (US); Life Technologies Corporation, Carlsbad, CA (US)

(72) Inventors: Michael Easton, Burlington, MA (US); Itisha Deokar, Del Mar, CA (US); Jonathan Wilson, Abington, MA (US); Siddharth Singh Chauhan, Greve (DK); Lars Weber-Hovendahl, Hvalsoe (DK); Stig Christensen, Greve (DK)

(21) Appl. No.: 19/380,726

(22) Filed: Nov. 5, 2025

Related U.S. Application Data
(60) Provisional application No. 63/716,447, filed on Nov. 5, 2024.

(51) Int. Cl. G01N 35/04

(52) U.S. Cl. CPC G01N 35/04; G01N 2035/0405

(57) ABSTRACT

Described herein are automated capping and de-capping systems and methods of use thereof. Automated capping and de-capping systems include a rack-support unit operable to support at least two types of a rack, a head unit comprising a plurality of cap-drivers, and a drive system. Each rack is operable to support a plurality of tubes having caps, the caps being a first cap type or a second cap type. The second cap type is different than the first cap type. The cap-drivers include a first interface portion operable to engage with the first cap type and a second interface portion operable to engage with the second cap type. The drive system is for moving the rack-support unit and the head unit relative to each other to facilitate engagement between the cap-drivers and the caps of the tubes to cap or de-cap the tubes.

### CROSS-REFERENCE TO RELATED APPLICATIONS

The present Non-Provisional application claims priority to the previously filed and currently pending U.S. Provisional Ser. No. 63/716,447 having a filing date of Nov. 5, 2024, the contents of which are hereby incorporated by reference in its entirety.

### FIELD OF THE INVENTION

The present disclosure pertains to automated capping and de-capping systems for use with laboratory tubes having different types of tube caps.

### BACKGROUND

Equipment for capping and de-capping tubes are generally known in laboratory settings. The equipment can receive a rack with multiple tubes and can quickly and accurately cap or de-cap the tubes. Each piece of equipment is compatible with one type of tube cap and one arrangement of tubes. Different manufacturers produce various cap types having different geometries and grip patterns. As one non-limiting embodiment, a first cap type can include a square drive socket, and a second cap type can include a rounded drive socket with vertical ribs on an outer wall. Tubes having the first cap type can only be capped and de-capped by equipment having a corresponding first driver shaped to engage the square drive socket, and tubes having the second cap type can only be capped and de-capped by equipment having a corresponding second driver shaped to engage the ribs on the outer wall.

Additionally, equipment can cap and de-cap one specific number of tubes in a specific arrangement. As one non-limiting embodiments, a first rack can support 96 tubes in a grid pattern, and a second rack can support 48 tubes in a diagonal pattern. Tubes in the first rack can only be capped and de-capped by equipment having drivers in the same arrangement as the first rack, and tubes can only be capped and de-capped by equipment having drivers in the same arrangement as the second rack.

Equipment does not exist that can cap and de-cap tubes in the first rack and the second rack, with the tubes having the first cap type and the second cap type. More generally, equipment does not exist that can cap and de-cap tubes in racks having different number of tubes in different arrangements, with the tubes having different types of caps. As such, laboratories often have different equipment for capping and de-capping tubes with different tube caps and in different arrangements.

### SUMMARY

One embodiment described herein is an automated capping and de-capping system including a rack-support unit operable to support at least two types of a rack, a head unit including a plurality of cap-drivers, and a drive system. Each rack is operable to support a plurality of tubes having caps, the caps being a first cap type or a second cap type. The second cap type is different than the first cap type. The cap-drivers include a first interface portion operable to engage with the first cap type and a second interface portion operable to engage with the second cap type. The drive system is for moving the rack-support unit and the head unit relative to each other to facilitate engagement between the cap-drivers and the caps of the tubes to cap or de-cap the tubes. In one aspect, the at least two types of racks include a rack operable to support 96 tubes, a rack operable to support 48 tubes, a rack operable to support 24 tubes, a rack operable to support 12 tubes, and a rack operable to support 6 tubes. In another aspect, the first interface portion is operable to interlock with the first cap type. In another aspect, the second interface portion is operable to interlock with the second cap type. In another aspect, the first cap type includes an annular wall and a plurality of ribs extending along an inner surface of the annular wall. In another aspect, the second cap type includes a square socket. In another aspect, the caps of the plurality of tubes includes more than two types of caps. In another aspect, the plurality of tubes are spaced along the rack in a grid pattern, a honeycomb pattern, or a diagonal pattern. In another aspect, the plurality of cap-drivers includes 96 cap-drivers. In another aspect, the plurality of cap-drivers includes 96 cap-drivers, and wherein each cap-driver can cap or de-cap each of the plurality of tube cap types placed in the rack, the rack operable to support 6 tubes, the rack operable to support 12 tubes, the rack operable to support 24 tubes, the rack operable to support 48 tubes, or the rack operable to support 96 tubes. In another aspect, each rack includes a plurality of slots, each slot configured to support one tube. In another aspect, each cap-driver can cap or de-cap each of the plurality of tube cap types placed in the rack, the rack operable to support up to 6 tubes, the rack operable to support up to 12 tubes, the rack operable to support up to 24 tubes, the rack operable to support up to 48 tubes, or the rack operable to support up to 96 tubes. In another aspect, when the rack is operable to support 96 tubes, each cap-driver aligns directly above one tube in the rack. In another aspect, when the rack is operable to support 48 tubes, half of the cap-drivers align directly above one tube in the rack. In another aspect, the other half of the cap-drivers align directly with gaps in the rack, the gaps defined between the tubes in the rack. In another aspect, the cap-drivers in the head unit can detect and identify different types of tube caps. In another aspect, the plurality of cap-drivers are housed on a cassette head. In another aspect, engagement between the cap-drivers and the caps of the tubes to cap or de-cap the tubes includes rotation of the cap-drivers and the caps.

Another embodiment described herein is an automated capping and de-capping system including a rack-support unit, a head unit including a plurality of cap drivers, and a drive system. The rack-support unit is operable to support a first rack operable to support a first plurality of tubes having caps, the caps being a first cap type or a second cap type, the second cap type different than the first cap type. The rack-support unit is operable to support a second rack operable to support a second plurality of tubes having caps, the caps being the first cap type or the second cap type. The second plurality of tubes includes less tubes than the first plurality of tubes. The cap-drivers are operable to engage with the first cap type and the second cap type. The drive system is for moving the rack-support unit and the head unit relative to each other to facilitate engagement between the cap-drivers and the caps of the tubes to cap or de-cap the tubes. In one aspect, the first rack is operable to support 96 tubes, 48 tubes, 24 tubes, 12 tubes, or 6 tubes. In another aspect, the second rack is operable to support 96 tubes, 48 tubes, 24 tubes, 12 tubes, or 6 tubes. In another aspect, the cap-drivers are operable to interlock with the first cap type and the second cap type. In another aspect, the first cap type includes an annular wall and a plurality of ribs extending along an inner surface of the annular wall. In another aspect, the second cap type includes a square socket. In another aspect, the caps of the plurality of tubes includes more than two types of caps. In another aspect, the first plurality of tubes are spaced along the first rack in a grid pattern, a honeycomb pattern, or a diagonal pattern. In another aspect, the second plurality of tubes are spaced along the second rack in a grid pattern, a honeycomb pattern, or a diagonal pattern. In another aspect, the plurality of cap-drivers includes 96 cap-drivers. In another aspect, the cap-drivers in the head unit can detect and identity different types of tube caps. In another aspect, the plurality of cap-drivers are housed on a cassette head. In another aspect, engagement between the cap-drivers and the caps of the first plurality of tubes to cap or de-cap the tubes includes rotation of the cap-drivers and the caps. In another aspect, engagement between the cap-drivers and the caps of the second plurality of tubes to cap or de-cap the tubes includes rotation of the cap-drivers and the caps.

Another embodiment described herein is a method of operating an automated capping and de-capping system including a plurality of cap-drivers having a first interface portion and a second interface portion. The method includes inserting a first rack with a first plurality of tubes into the system, the first plurality of tubes having first caps, the first caps being a first cap type or a second cap type, the second cap type different than the first cap type, detecting the type of the first caps, moving the cap-drivers a first depth to engage the first interface portions with the first caps in response to detecting the first cap type, moving the cap-drivers a second depth to engage the second interface portions with the first caps in response to detecting the second cap type, the second depth different than the first depth, inserting a second rack with a second plurality of tubes into the system, the second plurality of tubes having a different number of tubes than the first plurality of tubes, the second plurality of tubes having second caps, the second caps being the first cap type or the second cap type, detecting the type of the second caps, moving the cap-drivers the first depth to engage the first interface portions with the second caps in response to detecting the first cap type, and moving the cap-drivers the second depth to engage the second interface portions with the second caps in response to detecting the second cap type. In one aspect, the first rack is operable to support 96 tubes, 48 tubes, 24 tubes, 12 tubes, or 6 tubes. In another aspect, the second rack is operable to support 96 tubes, 48 tubes, 24 tubes, 12 tubes, or 6 tubes. In another aspect, the first cap type includes an annular wall and a plurality of ribs extending along an inner surface of the annular wall, and wherein the second cap type includes a square socket. In another aspect, the caps of the plurality of tubes includes more than two types of caps. In another aspect, the first plurality of tubes are spaced along the first rack in a grid pattern, a honeycomb pattern, or a diagonal pattern. In another aspect, the second plurality of tubes are spaced along the second rack in a grid pattern, a honeycomb pattern, or a diagonal pattern. In another aspect, the plurality of cap-drivers includes 96 cap-drivers. In another aspect, the plurality of cap-drivers are housed on a cassette head. In another aspect, engagement between the cap-drivers and the caps of the first plurality of tubes to cap or de-cap the tubes includes rotation of the cap-drivers and the caps. In another aspect, engagement between the cap-drivers and the caps of the second plurality of tubes to cap or de-cap the tubes includes rotation of the cap-drivers and the caps.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows a perspective view of an automated capping and de-capping system.

FIG. 2 shows a schematic view of the automated capping and de-capping system including a head unit.

FIG. 3 shows a perspective view of the rack and the plurality of tubes of FIG. 2.

FIG. 4 shows a top view of the rack and the plurality of tubes of FIG. 2.

FIG. 5 shows a perspective view of another example of an embodiment of a rack and plurality of tubes for use with the automated capping and de-capping system of FIG. 1.

FIG. 6 shows a top view of the rack and the plurality of tubes of FIG. 5.

FIG. 7 shows a perspective view of a cap of one of the tubes of FIG. 2.

FIG. 8 shows a top view of the cap of FIG. 7.

FIG. 9 shows a perspective view of a cap for use with one of the tubes of FIG. 2.

FIG. 10 shows a top view of the cap of FIG. 9.

FIG. 11 shows a perspective view of a cap of one of the tubes of FIG. 5.

FIG. 12 shows a perspective view of the head unit of FIG. 2.

FIG. 13 shows a perspective view of a cap-driver of the head unit of FIG. 2.

FIG. 14 shows a perspective view of a portion of the cap-driver of FIG. 13.

FIG. 15 shows a side view of a portion of the cap-driver of FIG. 13.

FIG. 16 shows an end view of the cap-driver of FIG. 13.

FIG. 17 shows a cross-sectional view of the cap-driver, taken along line 17-17 in FIG. 16.

FIG. 18 shows a cross-sectional view of the cap-driver, taken along line 18-18 in FIG. 16.

FIG. 19 shows another cap-driver for use in head unit of FIG. 2.

FIG. 20 shows a side view of the cap-driver of FIG. 19.

FIG. 21 shows another side view of the cap-driver of FIG. 19, rotated 90 degrees about a longitudinal axis relative to the cap-driver of FIG. 20.

FIG. 22 shows an end view of the cap-driver of FIG. 19.

FIG. 23 shows a cross-sectional view of the cap-driver, taken along line 23-23 in FIG. 21.

FIG. 24 shows a cross-sectional view of the cap-driver, taken along line 24-24 in FIG. 22.

FIG. 25 shows a perspective view of the cap-driver of FIG. 13 spaced apart from the cap of FIG. 7.

FIG. 26 shows a perspective view of the cap-driver of FIG. 13 engaged with the cap of FIG. 7.

FIG. 27 shows a perspective view of the cap-driver of FIG. 13 spaced apart from the cap of FIG. 9.

FIG. 28 shows a perspective view of the cap-driver of FIG. 13 engaged with the cap of FIG. 9.

FIG. 29 shows a cross-sectional view of the rack with the plurality of tubes engaged with the head unit of FIG. 2.

FIG. 30 shows a perspective view of five cap-drivers of FIG. 13 and five of the tubes of the rack of FIG. 5, four of the cap-drivers engaged with four of the tubes, and one of the cap-drivers adjacent one of the tubes.

FIG. 31 shows a perspective view of the one cap-driver adjacent the one tube of FIG. 30.

### DETAILED DESCRIPTION

Unless otherwise defined, all technical and scientific terms used herein have the same meaning as commonly understood by one of ordinary skill in the art. For example, any nomenclatures used in connection with, and techniques of biochemistry, molecular biology, immunology, microbiology, genetics, cell and tissue culture, and protein and nucleic acid chemistry described herein are well known and commonly used in the art. In case of conflict, the present disclosure, including definitions, will control. Exemplary methods and materials are described below, although methods and materials similar or equivalent to those described herein can be used in practice or testing of the embodiments and aspects described herein.

As used herein, terms such as “include,” “including,” “contain,” “containing,” “having,” and the like mean “comprising.” The present disclosure also contemplates other embodiments “comprising,” “consisting essentially of,” and “consisting of” the embodiments or elements presented herein, whether explicitly set forth or not. As used herein, “comprising,” is an “open-ended” term that does not exclude additional, unrecited elements or method steps. As used herein, “consisting essentially of” limits the scope of a claim to the specified materials or steps and those that do not materially affect the basic and novel characteristics of the claimed invention. As used herein, “consisting of” excludes any element, step, or ingredient not specified in the claim.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,”“an,”or “the”means “one or more”unless otherwise specified.

As used herein, the term “or”can be conjunctive or disjunctive.

As used herein, the term “and/or”refers to both the conjunctive and disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend\in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

All ranges disclosed herein include both end points as discrete values as well as all integers and fractions specified within the range. For example, a range of 0.1-2.0 includes 0.1, 0.2, 0.3, 0.4, . . . 2.0. If the end points are modified by the term “about,” the range specified is expanded by a variation of up to ±10% of any value within the range or within 3 or more standard deviations, including the end points, or as described above in the definition of “about.”

As used herein, the terms “room temperature,” “RT,” or “ambient temperature” refer to the typical temperature in an indoor laboratory setting. In one aspect, the laboratory setting is climate controlled to maintain the temperature at a substantially uniform temperature or with a specific range of temperatures. In one aspect, “room temperature” refers a temperature of about 15-30° C., including all integers and endpoints within the specified range. In another aspect, “room temperature” refers a temperature of about 15-30° C.; about 20-30° C.; about 22-30° C.; about 25-30° C.; about 27-30° C.; about 15-22° C.; about 15-25° C.; about 15-27° C.; about 20-22° C.; about 20-25° C.; about 20-27° C.; about 22-25° C.; about 22-27° C.; about 25-27° C.; about 15° C.±10%; about 20° C.±10%; about 22° C.±10%; about 25° C.±10%; about 27° C.±10%; ˜20° C., ˜22° C., ˜25° C., or ˜27° C., at standard atmospheric pressure.

As used herein, the terms “control,” or “reference” are used herein interchangeably. A “reference” or “control” level may be a predetermined value or range, which is employed as a baseline or benchmark against which to assess a measured result. “Control” also refers to control experiments or control cells.

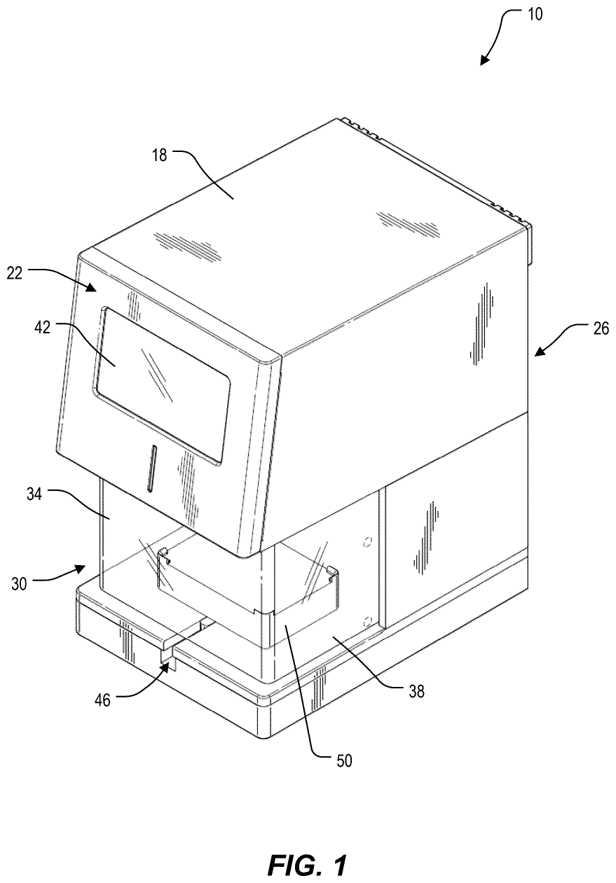

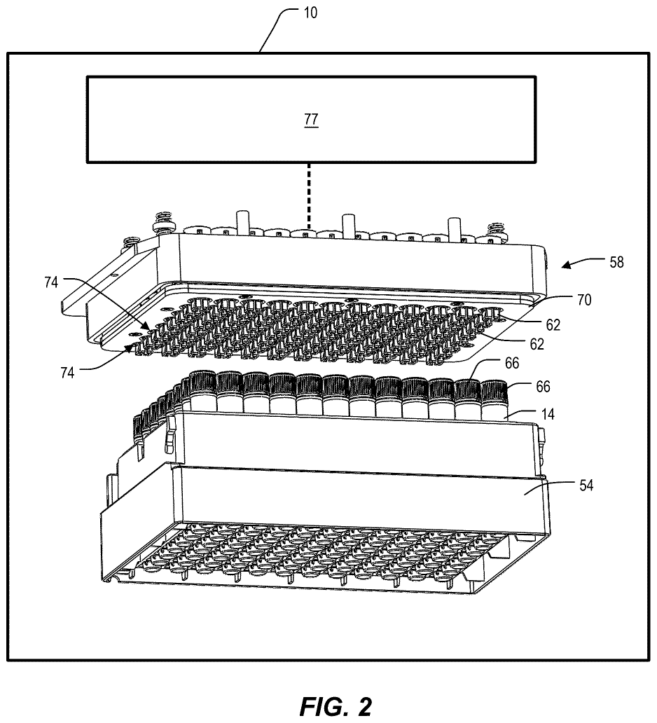

FIG. 1 illustrates an automated capping and de-capping system 10 (also referred to as a system 10) for capping and de-capping screw cap tubes 14 (shown in FIG. 2). The tubes 14 can also be referred to as test tubes 14 or sample tubes 14. The system 10 includes a housing 18.

The housing 18 defines a first side 22 (also referred to as a front side 22) and a second side 26 (also referred to as a back side 26). The housing 18 defines an operational area 30 (also referred to as a capping/de-capping area 30). The operational area 30 is on the first side 22 of the housing 18. The operational area 30 is configured to receive the tubes 14 (shown in FIG. 2) to facilitate caping and/or de-capping of the tubes 14. The system 10 can include a shield 34. The shield 34 selectively encloses the operational area 30. The shield 34 is movable relative to the housing 18 between an open position and a closed position. In the open position, the operational area 30 is accessible, such that tubes 14 (shown in FIG. 2) can be inserted into and removed from the operational area 30. In the closed position, the shield 34 engages a guide surface 38 of the system 10, such that the operational area 30 is sealed or closed. In the closed position, the tubes 14 (shown in FIG. 2) cannot be inserted into or removed from the operational area 30. However, in the closed position, the tubes 14 (shown in FIG. 2) can be capped and/or de-capped. The shield 34 can be composed of a transparent material (e.g., plexiglass, glass, etc.) to allow a user to see into the operational area 30 when the shield 34 is in the closed position. FIG. 1 illustrates the shield 34 in the closed position. It should be appreciated that in the open position, the shield 34 can be recessed into the housing 18, pivoted away from the housing 18, or otherwise moved to any suitable position to provide access to the operational area 30.

With continued reference to FIG. 1, the system 10 includes a display 42 (also referred to as a control panel 42). The display 42 can indicate information about the system 10 such as the operational status of the system 10, the battery life, or any other suitable information about the system 10 and/or the associated cap and de-cap process. The display 42 can also be used to control operation of the system 10. For example, the display 42 can be used to control moving the shield 34 between the open position and the closed position. The display 42 can also be used to begin a capping or de-capping operation. The illustrated display 42 is positioned on the first side 22 adjacent the shield 34. The display 42 adjacent the shield 34 allows a user to view the operational area 30 and the display 42 at the same time or quickly switch between viewing the operational area 30 and the display 42. In other embodiments, the shield 34 and the display 42 can positioned in other portions of the system 10 to improve the ease of use.

With continued reference to FIG. 1, the system 10 includes a track 46 extending through the guide surface 38. The track 46 can be a linear recess extending through the guide surface 38. The track 46 can extend in a direction defined between the first side 22 and the second side 26. The system 10 includes a rack-support unit 50 slidably received in the track 46. The rack-support unit 50 is configured to support a rack 54 (also referred to as a first rack 54 or a first type of rack 54) that holds a plurality of tubes 14 (shown in FIG. 2). The rack-support unit 50 is slidable along the track 46 to properly orient or align the rack 54 within the operational area 30 to initiate a capping or de-capping operation.

FIG. 2 illustrates a head unit 58 of the system 10. The head unit 58 is positioned within the housing 18 of the system 10 on a side of the operational area 30 opposite the guide surface 38 (shown in FIG. 1). The head unit 58 is configured to cap and de-cap the tubes 14. The head unit 58 includes a cap-driver 62. The illustrated head unit 58 includes a plurality of cap-drivers 62. Each cap-driver 62 is configured to engage with a cap 66 of a tube 14. In response to engagement, each cap-driver 62 is configured to remove the cap 66 from a body of the tube 14 and/or couple the cap 66 to the body of the respective tube 14. The illustrated head unit 58 includes ninety-six (96) cap-drivers 62. In other embodiments, the head unit 58 can include forty-eight (48) cap-drivers 62, twenty-four (24) cap-drivers 62, twelve (12) cap-drivers 62, or any other suitable number of cap-drivers 62 to cap and de-cap a plurality of tubes 14.

In some examples of embodiments, the head unit 58 can include one or more sensors (not shown) to detect the tubes 14 and/or the rack 54. The sensors (not shown) can identify a type of cap 66 on the tubes 14, the position of the tubes 14, the shape of the rack 54, the position of the rack 54, or any desired characteristic of the tubes 14 and/or the rack 54. The system 10 can include sensors (not shown) that detect a position and/or size of the rack 54 and a controller (not shown) that can position the rack 54 based on the detected position and/or size.

With continued reference to FIG. 2, the head unit 58 includes a panel 70 (also referred to as a cassette head 70). The panel 70 includes a plurality of apertures 74. Each aperture 74 receives an associated cap-driver 62. Accordingly, in the illustrated embodiment, one cap-driver 62 extends through each aperture 74. The head unit 58 also includes a drive system 77. The drive system 77 is configured to move the cap-drivers 62 toward the tubes 14. More specifically, the drive system 77 is configured to extend and retract each cap-driver 62 relative to the tubes 14. In some examples of embodiments, cap-drivers 62 can be moved with the panel 70 relative to the tubes 14. In other examples of embodiments, the cap-drivers can be moved relative to the panel 70 and the tubes 14. It should be appreciated that the drive system 77 can also include the track 46 (shown in FIG. 1). As such, the drive system 77 can move the rack 54 along the track 46 to align the rack 54 with the cap-drivers 62. The drive system 77 can then move the cap-drivers 62 toward and away from the rack 54.

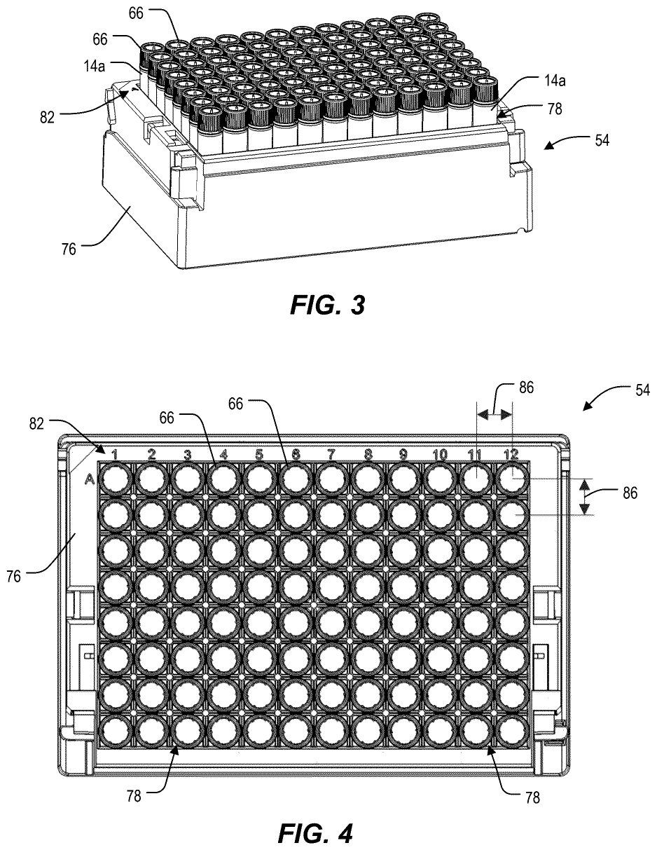

With reference now to FIGS. 3 and 4, the rack 54 includes a rack body 76 and a plurality of slots 78 extending into the rack body 76. Each slot 78 can receive one tube 14. The illustrated slots 78 define a square cross-section. In other examples of embodiments, each slot 78 can have a circular, rectangular, or other suitable geometric cross-section to support a tube 14. The slots 78 can include anti-rotation features (not shown) to inhibit the tubes 14 from rotating relative to the slots 78 (and the rack body 76) while the tubes 14 are being capped or de-capped. A nonlimiting examples of an anti-rotation feature can include one or more ribs that are configured to engage the tubes 14, one or more flanges that are configured to engage the tubes 14, or any other suitable structural feature configured to limit relative rotation between each tube 14 and the respective slot 78.

The slots 78 of the rack 54 are arranged in a grid pattern. More specifically, the slots 78 are arranged in a twelve (12) by eight (8) grid pattern. As such, the illustrated rack 54 includes ninety-six (96) slots 78. Accordingly, the illustrated rack 54 can support ninety-six (96) tubes 14. The rack 54 can include indicia 82 to label each row and/or column of slots 78.

The illustrated rack 54 includes numbers and letters to label rows and columns, respectively. Each slot 78 is offset from adjacent slots by a first distance 86 (shown in FIG. 4). The first distance 86 is measured from a center of a slot 78 to a center of an adjacent slot 78 (i.e., a slot 78 in an adjacent row or an adjacent column). Stated another way, each slot 78 is offset from adjacent slots 78 in the same row and column by the first distance 86. The illustrated first distance 86 is nine (9) millimeters. In other examples of embodiments, the first distance 86 can be any suitable distance to arrange the slots 78 and tubes 14 along the rack body 76. In other examples of embodiments, the slots 78 can be arranged in a honeycomb pattern, a diagonal pattern, or any suitable pattern to align the tubes 14 with the cap-drivers 62. The illustrated tubes 14 are first tubes 14a. The first tubes 14a define a first volume (not shown) to receive test material. The first volume can be, for example, 1.4 milliliters (mL), 1.0 mL, or any suitable volume to fit into the slots 78.

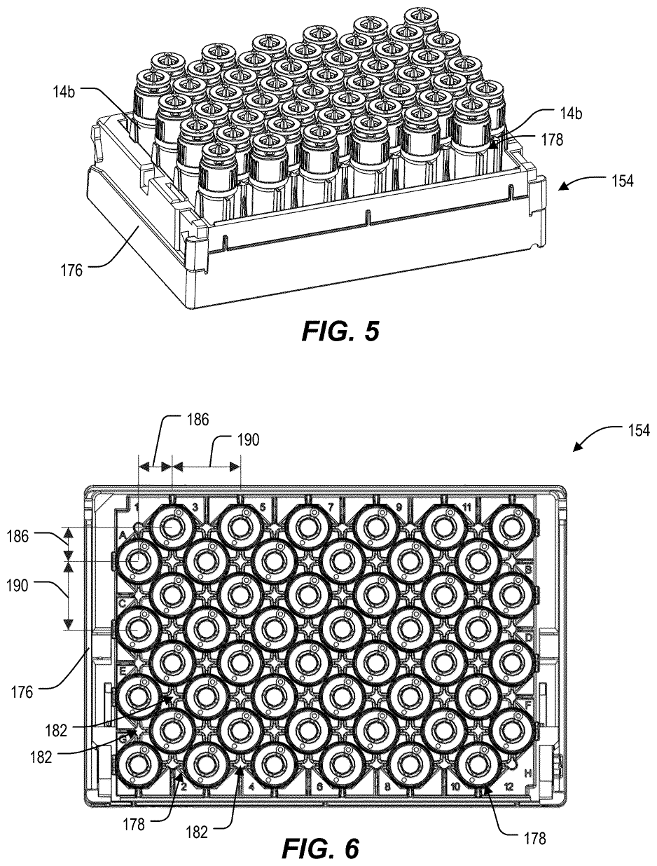

FIGS. 5 and 6 illustrate another rack 154 (also referred to as a second rack 154 or a second type of rack) for use with the system 10. The rack 154 includes a rack body 176 and plurality of slots 178 extending into the rack body 176. The rack body 176 of the second rack 154 can include the length and width as the rack body 76 of the first rack 54. By having the same footprint, the first rack 54 and the second rack 154 can each fit on the rack-support unit 50 (shown in FIG. 1) and be properly aligned within the operational area 30 (shown in FIG. 1). Each slot 178 can receive one tube 14. The illustrated slots 178 are in an offset row/offset column pattern (also referred to as a diagonal pattern). Each row of slots 178 is offset from adjacent rows of slots 178, and each column of slots 178 is offset from adjacent columns of slots 178. The illustrated slots 178 are arranged in a twelve (12) by four (4) pattern (also referred to as a six (6) by eight (8) pattern), with adjacent slots 178 being offset from each other. As such, the illustrated rack 154 includes forty-eight (48) slots 178. Accordingly, the illustrated rack 154 can support forty-eight (48) tubes 14.

With reference to FIG. 6, the rack 154 defines gaps 182 positioned between adjacent slots 178. Stated another way, each slot 178 is spaced from an adjacent slot 178, both horizontally (along the row) and vertically (along the column), by a gap 182. However, diagonally adjacent slots 178 are not separated by a gap. One cap-driver 62 is configured to extend into each gap 182, which is described in further detail below. Each slot 178 is horizontally and vertically offset from diagonally adjacent slots by a first distance 186 (shown in FIG. 6). The first distance 186 is measured from a center of a slot 178 to a center of a diagonally adjacent slot 178 (i.e., a slot 178 in an adjacent row and an adjacent column). The first distance 186 is measured along the length of the rows or columns. Each slot 178 is also offset from adjacent slots 178 in the same row and the same column by a second distance 190. The second distance 190 is measured from a center of a slot 178 to a center of an adjacent slot 178 in the same row or the same column (i.e., a slot 178 in an adjacent row or an adjacent column). The first distance 186 is measured along the length of the rows or columns. The second distance 190 is not equal to the first distance 186. The illustrated second distance 190 is greater than the first distance 186. In other examples of embodiments, the second distance 190 can be equal to or smaller than the first distance 186. The illustrated first distance 186 is nine (9) millimeters, and the illustrated second distance 190 is eighteen (18) millimeters. In other examples of embodiments, the first distance 186 and the second distance 190 can be any suitable distance to arrange the slots 178 and tubes 14 along the rack body 176. The illustrated tubes 14 are second tubes 14b. The second tubes 14b define a second volume (not shown) to receive test material. The second volume of the second tubes 14b can be greater than the first volume of the first tubes 14a. The second volume can be, for example, 1.5 mL, 2.4 mL, 5 mL, or any suitable volume to fit into the slots 178. The rack 154 includes many similar features as the rack 54. It should be appreciated that the rack 154 can include any components, features, or function as described herein with reference to the rack 54. Similarly, the rack 54 can include any components, features, or function as described herein with reference to the rack 154.

The first rack 54 can support up to ninety-six (96) first tubes 14a, and the second rack 154 can support up to forty-eight (48) second tubes 14b. It should be appreciated that the system 10 can receive other racks (not shown) to cap and de-cap tubes within the other racks. The other racks or other types or racks can have any number of slots to receive a corresponding number of tubes. For example, the other types of racks can receive thirty-six (36) tubes, twenty-four (24) tubes, twelve (12) tubes, six (6) tubes, or any other suitable number of tubes. The slot in the other racks are spaced apart by the first distance 86, 186 or a multiple of the first distance (e.g., the second distance 190). The cap-drivers 62 are spaced apart by the first distance 86, 186. As such, the other racks will be compatible with the cap-drivers 62 if the tubes received in the other racks are also spaced apart by the first distance 86, 186 or a multiple of the first distance 86, 186. The tubes supported by the other racks can be differently sized than the first tubes 14a and/or the second tubes 14b. Each other rack can have a body (not shown) with the same footprint or cross-section as the bodies 76, 176 of the respective first and second racks 54, 154 to properly fit on the rack-support unit 50 (shown in FIG. 1) to be properly aligned in the operational area 30 (shown in FIG. 1).

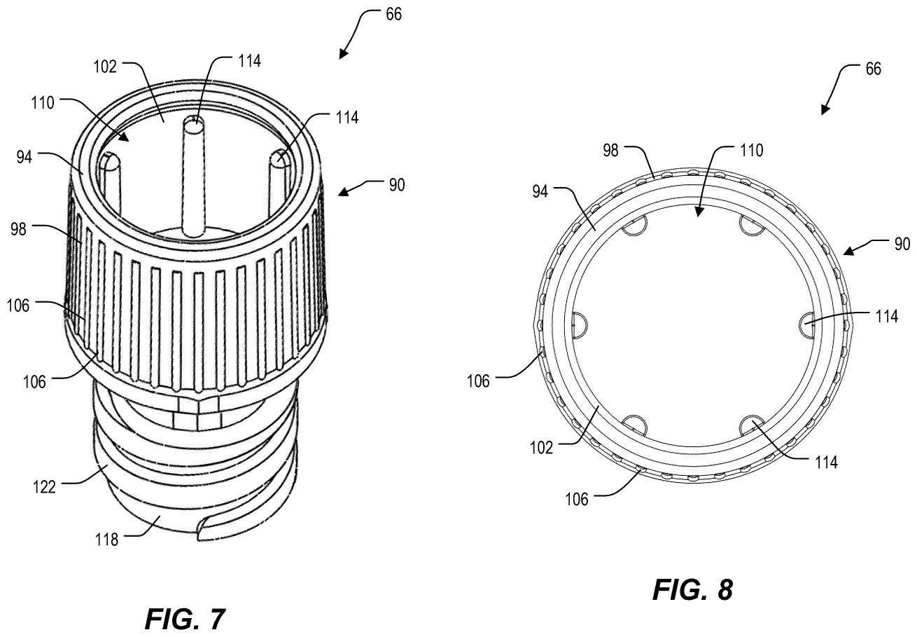

FIGS. 7 and 8 illustrate the cap 66 (also referred to as a first cap 66). The cap 66 can be referred to as, for example, a MATRIX cap. MATRIX is a registered trademark to Matrix Technologies LLC, having corporate offices at 22 Alpha Road Chelmsford, Massachusetts, United States 01824. The cap 66 includes a head 90. The head 90 includes a head wall 94. The head wall 94 is an annular wall 94. The head wall 94 includes an outer surface 98 and an inner surface 102. The head 90 includes a plurality of ridges 106 (or knurls 106) extending along the outer surface 98. The ridges 106 provide a gripping surface on the outer surface 98 to, for example, assist a user to manually rotate the cap 66 relative to the tube 14. The illustrated ridges 106 extend vertically or along a length of the cap 66. In other examples of embodiments, the ridges 106 can extend horizontally, annularly around the outer surface 98, or in any suitable direction to improve the grip of the outer surface 98. The inner surface 102 defines a head cavity 110. The head 90 also includes a plurality of ribs 114 (also referred to as projections 114) extending along the inner surface 102. The ribs 114 allow the cap 66 to be gripped by the system 10 to facilitate removal of the cap 66 from the associated tube 14 or coupling the cap 66 to the associated tube 14, which is described in further detail below. The illustrated ribs 114 extend vertically or along a length of the cap 66, or in the same direction as the ridges 106. In other examples of embodiments, the ribs 114 can extend horizontally, annularly around the inner surface 102, or in any suitable direction to improve the grip of the inner surface 102. The illustrated cap 66 includes six (6) ribs 114 evenly patterned or spaced around the inner surface 102. In other examples of embodiments, the cap 66 can include any suitable number of ribs 114 spaced in any configuration to improve the grip of the inner surface 102.

The cap 66 and any other caps having the ribs 114 patterned around the inner surface 102 can be referred to as a first cap type. In some examples of embodiments, each cap 66 can be shaped to permit cap-drivers 62 to pass between adjacent caps 66 and into a gap 182 (shown in FIG. 6). For example, each cap 66 can include detents, projections, or any suitable geometry on the outer surface 98 to permit cap-drivers 62 to fit in the gaps 182.

With specific reference to FIG. 7, the cap 66 includes a stem 118. The stem 118 extends from the head 90. The stem 118 is configured be inserted into a tube 14. The stem 118 includes threads 122 (also referred to as first threads 122). The threads 122 are disposed along an outer surface of the stem 118. As such, the threads 122 can also be referred to as external threads 122 or outer threads 122. The threads 122 are configured to engage corresponding internally threaded tubes 14. The internally threaded tubes 14 include threads (not shown) on an inner surface. The cap 66 can be referred to as a male connection, and the internally threaded tubes 14 can be referred to as a female connection configured to receive the male connection.

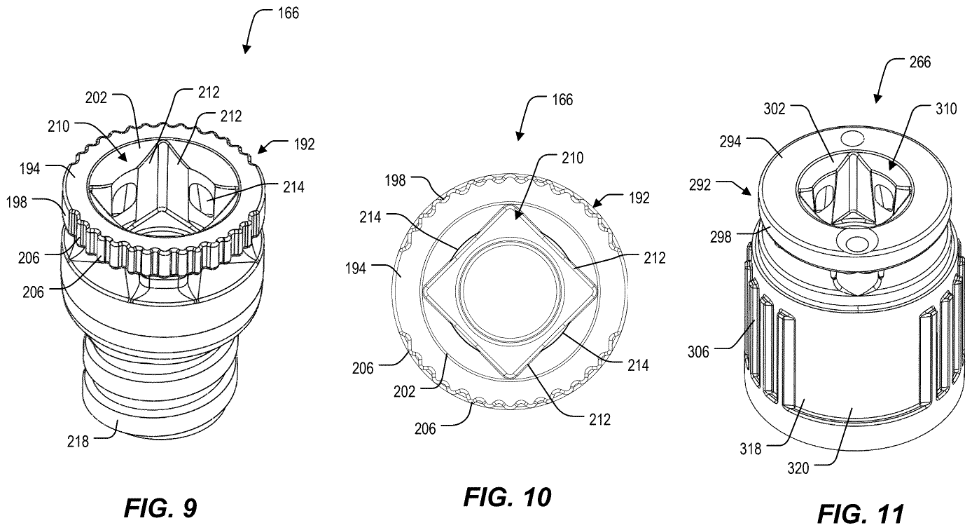

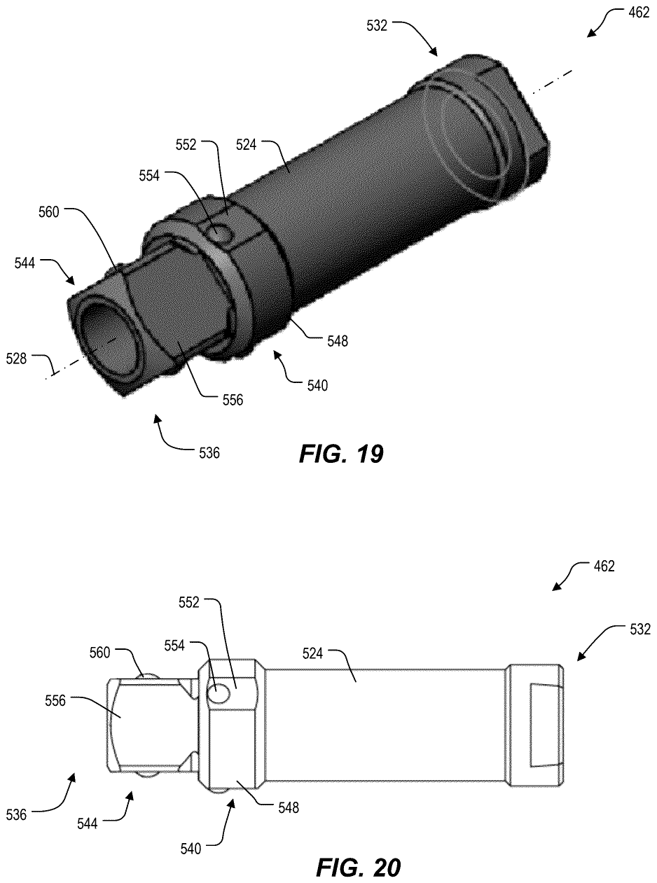

FIGS. 9 and 10 illustrate another cap 166 (also referred to as a second cap 166) for use with the tubes 14. The cap 166 can be referred to as, for example, a first NUNC cap 166. NUNC is a registered trademark to Nunc A/S, having corporate offices at Kamstrupvej 90 Roskilde, Denmark, DK-4000. The cap 166 includes a head 192. The head 192 includes a head wall 194. The head wall 194 includes an outer surface 198 and an inner surface 202. The head 192 includes a plurality of ridges 206 extending along the outer surface 198. The ridges 206 provide texture on the outer surface 198. The ridges 206 improve a grip on the outer surface 198 to, for example, allow a user to manually rotate the cap 166. The illustrated ridges 206 extend vertically or along a length of the cap 166. In other examples of embodiments, the ridges 206 can extend horizontally, annularly around the outer surface 198, or in any suitable direction to improve the grip of the outer surface 198. The inner surface 202 defines a drive socket 210 (also referred to as a head cavity 210). The drive socket 210 allows the cap 166 to be gripped by the system 10 to facilitate removal of the cap 166 from the associated tube 14 or coupling the cap 166 to the associated tube 14, which is described in further detail below. The illustrated drive socket 210 is a square drive socket. As such, the drive socket 210 includes four driven faces 212. Each driven face 212 includes a detent 214. Each detent 214 is located in the center of the respective face 212. The detents 214 can, for example, be engaged by the associated cap-driver 62 (shown in FIG. 19) to improve the connection between the cap-driver 62 and the cap 166. In other embodiments, the drive socket 210 can include any other suitable features to improve the connection between the cap-driver 62 and the cap 166 to facilitate coupling or decoupling the cap 66 from the associated tube 14. The cap 166 and any other caps having the drive socket 210 can be referred to as a second cap type.

With specific reference to FIG. 9, the cap 166 includes a stem 218. The stem 218 extends from the head 192. The stem 218 is similar to the stem 118 of the cap 66 (shown in FIG. 7). It should be appreciated that the stem 218 can include any components, features, or function as described herein with reference to the stem 118.

FIG. 11 illustrates another cap 266 (also referred to as a third cap 266) for use with tubes 14. The cap 266 can be referred to as, for example, a second NUNC cap 266. The cap 266 includes a head 292. The head 292 includes a head wall 294. The head wall 294 includes an outer surface 298 and an inner surface 302. The inner surface 302 defines a drive socket 310 (also referred to as a head cavity 310). The drive socket 310 can include any components, features, or function as described herein with reference to the drive socket 210 (shown in FIGS. 9 and 10). The cap 266 can be referred to as the second cap type.

With continued reference to FIG. 11, the cap 266 includes a cap body 318. The cap body 318 extends from the head 292. The cap body 318 is configured to engage a tube 14 to couple the cap 266 to the tube 14. The cap body 318 includes an outer body surface 320 and an inner body surface (not shown). The cap body 318 includes a plurality of ridges 306 extending along the outer body surface 320. The ridges 306 can include any components, features, or function as described herein with reference to the ridges 106 (shown in FIG. 7) and/or the ridges 206 (shown in FIG. 9). The cap body 318 includes threads (not shown) on the inner body surface. As such, the threads (not shown) can also be referred to as internal threads or inner threads. The threads are configured to engage corresponding externally threaded tubes 14. The externally threaded tubes 14 include threads (not shown) on an outer surface. The cap 266 can be referred to as a female connection, and the externally threaded tubes 14 can be referred to as a male connection configured to be received in the female connection.

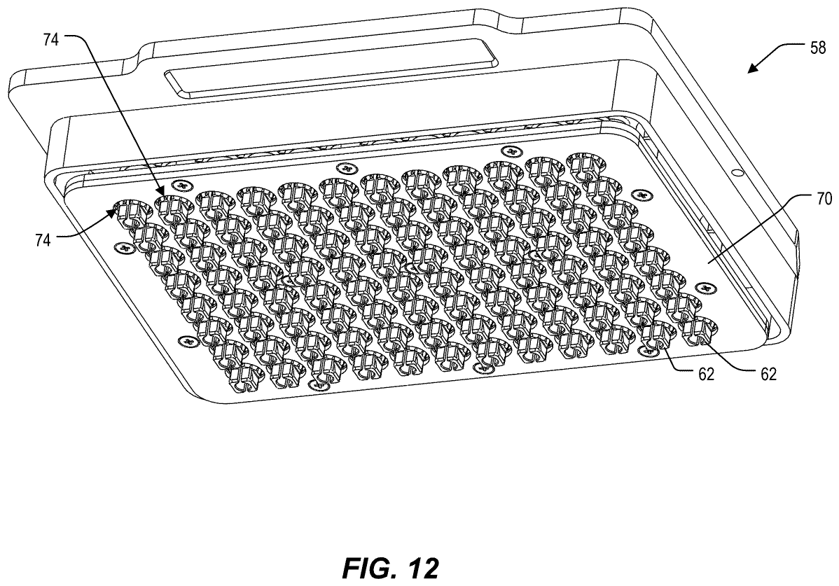

With reference to FIG. 12, the apertures 74 and associated cap-drivers 62 are arranged in a grid pattern along the panel 70. More specifically, the illustrated apertures 74 are arranged in a twelve (12) by eight (8) grid. Accordingly, the panel 70 includes ninety-six (96) apertures 74. The head unit 58 includes ninety-six (96) cap-drivers 62 that each extend through one of the respective apertures 74. The grid pattern of the cap-drivers 62 is identical to the grid pattern of the rack 54 (shown in FIG. 4). Each cap-driver 62 can be offset from adjacent cap-drivers 62 by the first distance 86 (shown in FIG. 4). As such, each cap-driver 62 is configured to engage with one tube 14 received in the rack 54, such that each cap-driver 62 engages an associated tube 14. In other examples of embodiments with other racks, each rack has a different pattern such that the cap-drivers 62 either engage a tube 14 or are received in a gap 182.

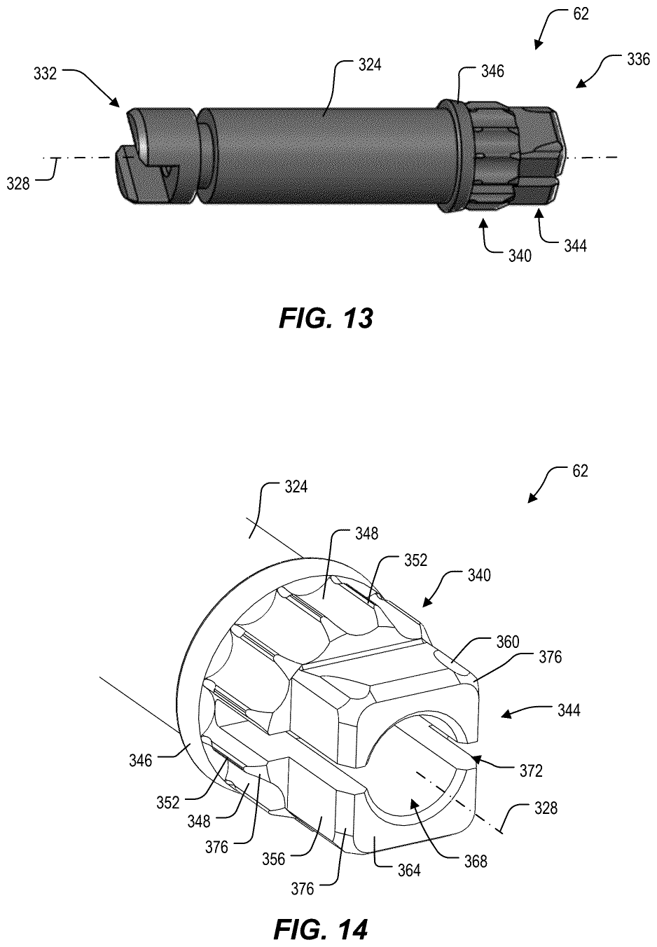

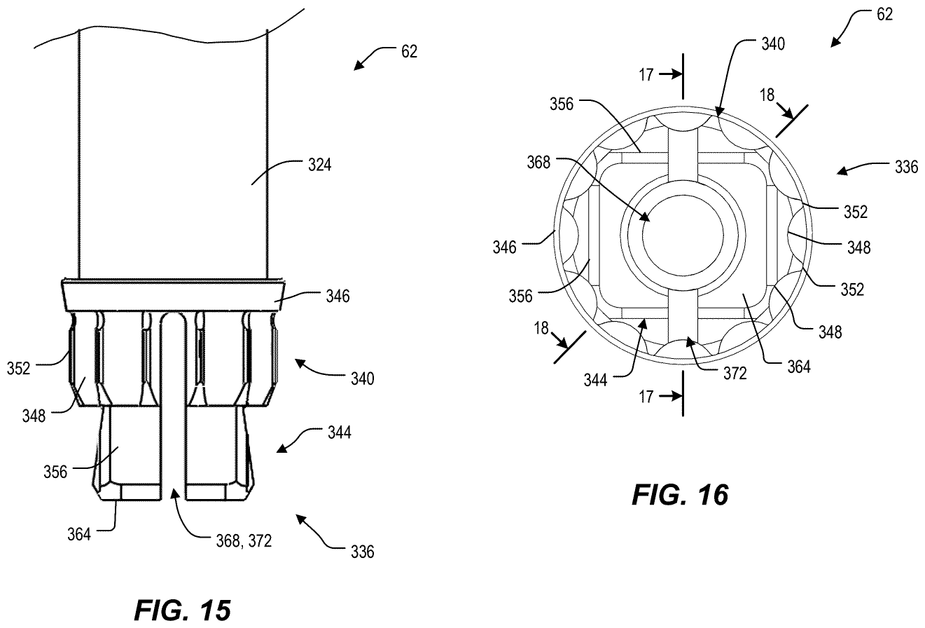

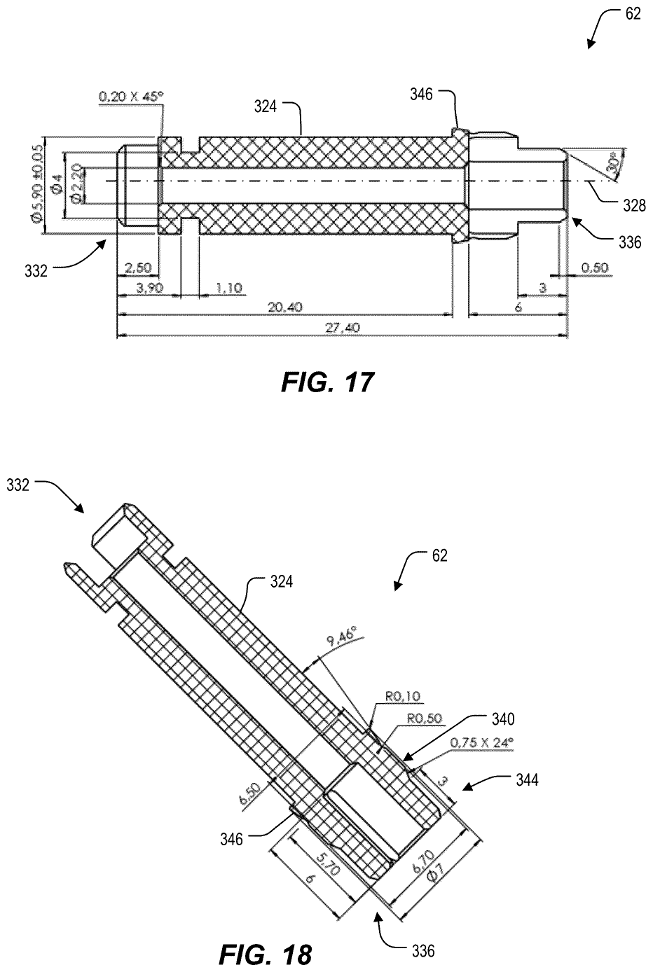

FIGS. 13-18 illustrate an embodiment of the cap-driver 62 (also referred to as a first cap-driver 62) for use in the system 10. With reference to FIG. 13, each cap-driver 62 includes a shaft 324 and a longitudinal axis 328 extending through the shaft 324. The shaft 324 is cylindrical. In other embodiments, the shaft 324 can be rectangular, triangular, or any other shape. Each cap-driver 62 includes an actuation end 332 (also referred to as a first end 332) on a first side of the shaft 324 and an interface end 336 (also referred to as a second end 336) on a second side of the shaft 324 opposite the actuation end 332. The actuation end 332 engages the drive system 77 (shown in FIG. 2). The drive system 77 is configured to extend and retract each cap-driver 62 through engagement with the actuation end 332.

With reference to FIGS. 13-18, each interface end 336 includes a first interface portion 340 and a second interface portion 344. Each first interface portion 340 is configured to engage (or interlock with) an associated first cap 66 (shown in FIG. 7) to selectively couple the first cap 66 to the tube 14 or decouple the first cap 66 from the tube 14. Stated another way, each first interface portion 340 is configured to engage a cap of the first cap type. Each first interface portion 340 is shaped to engage the inner surface 102 and the ribs 114 (shown in FIG. 7) of the first cap 66. Each second interface portion 344 is configured to engage (or interlock with) an associated second cap 166 (shown in FIG. 9) or third cap 266 (shown in FIG. 11) to selectively cap or de-cap the tube 14. Stated another way, each second interface portion 344 is configured to engage a cap of the second cap type. Each second interface portion 344 is shaped to engage the drive socket 210 of the second cap 166 and the drive socket 310 of the third cap 266. The first interface portion 340 is positioned between the shaft 324 and the second interface portion 344 (shown in FIGS. 13-15). More specifically, the first interface portion 340 is positioned between a ring 346 and the second interface portion 344. Each ring 346 extends annularly around the respective cap-driver 62.

With reference to FIG. 14, each first interface portion 340 includes a plurality of arcuate portions 348 and a plurality of peaks 352. The arcuate portions 348 and peaks 352 alternate around the longitudinal axis 328 (shown in FIG. 13). As such, one arcuate portion 348 is positioned between two peaks 352. Each arcuate portion 348 is concave. Stated another way, each peak 352 extends further radially from the longitudinal axis 328 than each arcuate portion 348. Each arcuate portion 348 is shaped to engage a rib 114 of the first cap 66 (shown in FIG. 7). Each rib 114 is engaged by an arcuate portion 348, such that rotation of the cap-driver 62 causes rotation of the associated first cap 66. Each arcuate portion 348 can define the same radius as each rib 114. Alternatively, each arcuate portion 348 can define substantially the same radius as each rib 114. The number of and arrangement of arcuate portions 348 is associated with the number of and arrangement of the ribs 114. The illustrated first interface portion 340 includes twelve (12) arcuate portions 348 and twelve (12) peaks 352 evenly patterned or spaced around the longitudinal axis 328 (shown in FIG. 13). As such, every other arcuate portion 348 is configured to engage one rib 114. In other embodiments, the first interface portion 340 can include a different number of arcuate portions 348 and peaks 352 that is associated with the number of ribs 114. For example, the interface portion 340 can include six (6) arcuate portions 348 and peaks 352, such that each arcuate portion 348 engages one rib 114.

With continued reference to FIG. 14, each second interface portion 340 includes a plurality of drive faces 356. Each drive face 356 is configured to engage a corresponding driven face 212 of the second or third caps 166, 266 to rotate the second or third cap 166, 266 (shown in FIGS. 9 and 11, respectively). The illustrated second interface portion 340 includes four drive faces 356 forming a square drive. In other embodiments, the second interface portion 340 can include any number of drive faces 356 in any shape to correspond with the drive sockets 210, 310 of the second and third caps 166, 266 (shown in FIGS. 9 and 11, respectively). Each second interface portion 340 can include cutouts 360 on the drive faces 356. In the illustrated embodiment, two opposing drive faces 356 each include two cutouts 360. Each cutout 360 is positioned adjacent a corner between adjacent drive faces 356. The cutouts 360 can facilitate engagement between the second interface portion 340 and the corresponding second or third cap 166, 266. Each second interface portion 340 also includes an end face 364. The end face 364 is the outermost portion of each interface end 336. The end face 364 is flat.

The interface end 336 includes a central bore 368 and a slot 372 extending through both the first interface portion 340 and the second interface portion 344. The central bore 368 extends along the longitudinal axis 328. The slot 372 intersects the central bore 368 and extends perpendicular through two drive faces 356 and parallel to two drive faces 356. The central bore 368 and slot 372 can receive projections or material on the caps 66, 166, 266 when the interface end 336 engages the associated cap 66, 166, 266.

The first and second interface portions 340, 344 includes a plurality of chamfered edges 376. The first interface portion 340 includes chamfered edges 376 between adjacent arcuate portions 348. The second interface portion 344 includes chamfered edges 376 at corners between adjacent drive face 356 and the end face 364. The chamfered edges 376 can facilitate engagement between the interface end 336 and the associated caps 66, 166, 266.

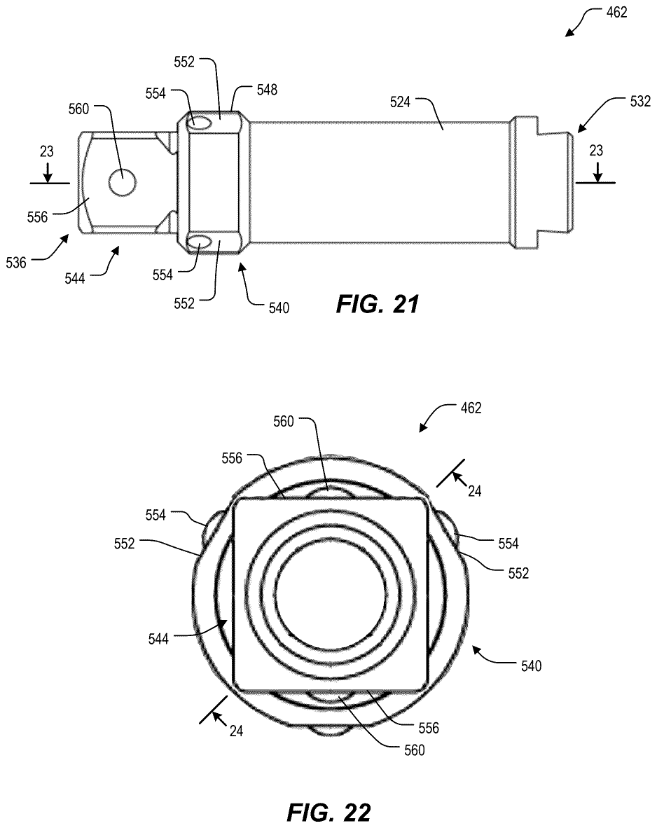

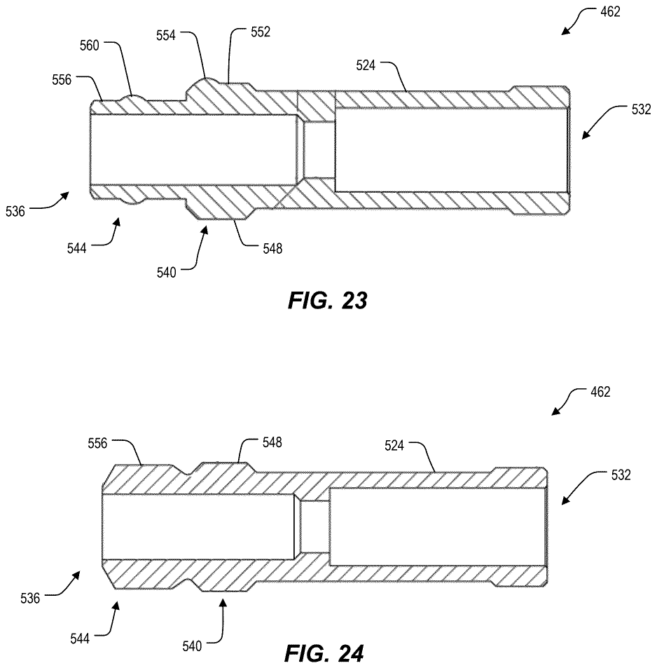

FIGS. 19-24 illustrate another embodiment of a cap-driver 462 (also referred to as a second cap-driver 462) for use in the system 10. One second cap-driver 462 can be used in place of each first cap-driver 62. It should be appreciated that each second cap-driver 462 can have any feature as described herein with reference to the first cap-driver 62. Similarly, each first cap-driver 62 can have any feature as described herein with reference to the second cap-driver 462.

FIGS. 19-24 illustrate another embodiment of a cap-driver 462 (also referred to as a second cap-driver 462) for use in the system 10. One second cap-driver 462 can be used in place of each first cap-driver 62. It should be appreciated that each second cap-driver 462 can have any feature as described herein with reference to the first cap-driver 62. Similarly, each first cap-driver 62 can have any feature as described herein with reference to the second cap-driver 462. With reference to FIG. 19, each cap-driver 462 includes a shaft 524 and a longitudinal axis 528 extending through the shaft 524. Each cap-driver 62 includes an actuation end 532 (also referred to as a first end 532) on a first side of the shaft 524 and an interface end 536 (also referred to as a second end 536) on a second side of the shaft 524 opposite the actuation end 532. The actuation end 532 engages the drive system 77 (shown in FIG. 2). The drive system 77 is configured to extend and retract each cap-driver 462 through engagement with the actuation end 532.

With reference to FIGS. 19-24, each interface end 536 includes a first interface portion 540 and a second interface portion 544. Each first interface portion 540 is configured to engage an associated first cap 66 (shown in FIG. 7) to selectively couple the first cap 66 to the tube 14 or decouple the first cap 66 from the tube 14. More specifically, each first interface portion 540 is shaped to engage the inner surface 102 and the ribs 114 (shown in FIG. 7) of the first cap 66. Each second interface portion 544 is configured to engage an associated second cap 166 (shown in FIG. 9) or third cap 266 (shown in FIG. 11) to selectively couple the second or third cap 166, 266 to the tube 14 or decouple the second or third cap 166, 266 from the tube 14. More specifically, each second interface portion 544 is shaped to engage the drive socket 210 of the second cap 166 and the drive socket 310 of the third cap 266. The first interface portion 540 is positioned between the shaft 524 and the second interface portion 544 (shown in FIGS. 13-15).

Each first interface portion 540 includes an annular ring 548. Each ring 548 extends around the cap-driver 462. Each first interface portion 540 includes a detent 552 in the ring 548. Each detent 552 is defined as a recessed portion of the ring 548. Each first interface portion 540 also includes a projection 554 (also referred to as a first projection 554) extending from each detent 552. Each illustrated projection 554 is circular and extends from a central portion of the corresponding detent 552. The projections 554 are configured to engage the inner surface 102 and/or the ribs 114 of the first cap 66, such that rotation of the cap-driver 462 causes rotation of the associated first cap 66. The illustrated first interface portion 540 includes three detents 552 and projections 554 evenly patterned around the longitudinal axis 528. The number of and arrangement of detents 552 and projections 554 can be associated with the number of and arrangement of the ribs 114. The illustrated first interface portion 340 includes three (3) detents 552 and projections 554 evenly patterned or spaced around the longitudinal axis 528. As such, every projection 554 is configured to engage one rib 114 or every other rib 114. In other embodiments, the first interface portion 540 can include a different number of detents 552 and projections 554 that is associated with the number of ribs 114. For example, the interface portion 340 can include six (6) detents 552 and projections 554, such that each projection 554 engages one rib 114.

Each second interface portion 540 includes a plurality of drive faces 556. Each drive face 556 is configured to engage a corresponding driven face 212 of the second or third caps 166, 266 to rotate the second or third cap 166, 266 (shown in FIGS. 9 and 11, respectively). The illustrated second interface portion 540 includes four drive faces 556 forming a square drive. Each second interface portion 540 can include projections 560 (also referred to as second projections 560) on the drive faces 556. In the illustrated embodiment, two opposing drive faces 556 each include one projection 560. The second projections 560 can function the same as the first projections 554. The second projections 560 can engage corresponding detents 214 on the drive sockets 210, 310 to improve the connection between the second interface portion 540 and the cap 166, 266.

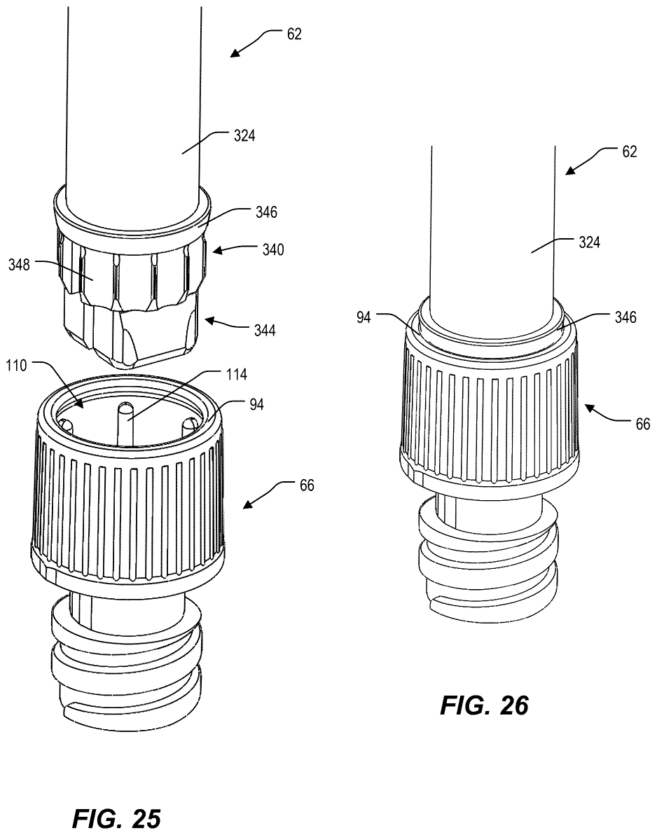

FIGS. 25 and 26 illustrate the first cap-driver 62 adjacent the first cap 66 and in engagement with the first cap 66, respectively. With reference to FIG. 25, the first cap-driver 62 is aligned with the first cap 66 prior to the interface end 336 being inserted into the head cavity 110. With reference to FIG. 26, the interface end 336 is entirely inserted into the head cavity 110, such that the ring 346 engages a top surface of the head wall 94 of the first cap 66. Each rib 114 of the first cap 66 is engaged with an associated arcuate portion 348 of the cap-driver 62 (not shown). Rotation of the first cap-driver 62 would cause the cap 66 to rotate therewith.

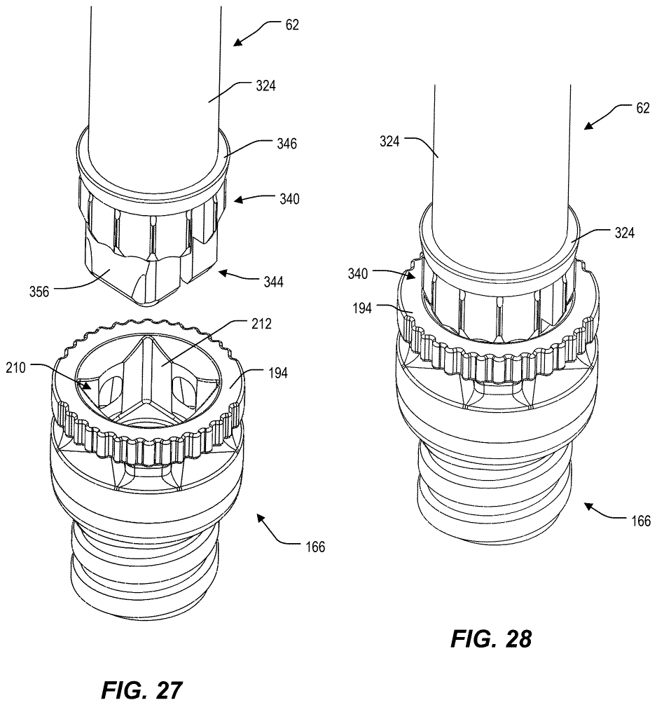

FIGS. 27 and 28 illustrate the first cap-driver 62 adjacent the second cap 166 and in engagement with the second cap 166, respectively. With reference to FIG. 27, the first cap-driver 62 is aligned with the second cap 166 prior to the interface end 336 being inserted into the head cavity 210. With reference to FIG. 28, the second interface portion 344 is inserted into the head cavity 210 and the first interface portion 344 remains outside of the head cavity 210. In some embodiments, the first interface portion 344 can engage the head wall 194. Each drive face 356 is engaged with an associated driven face 212 (not shown). Rotation of the first cap-driver 62 would cause the cap 166 to rotate therewith.

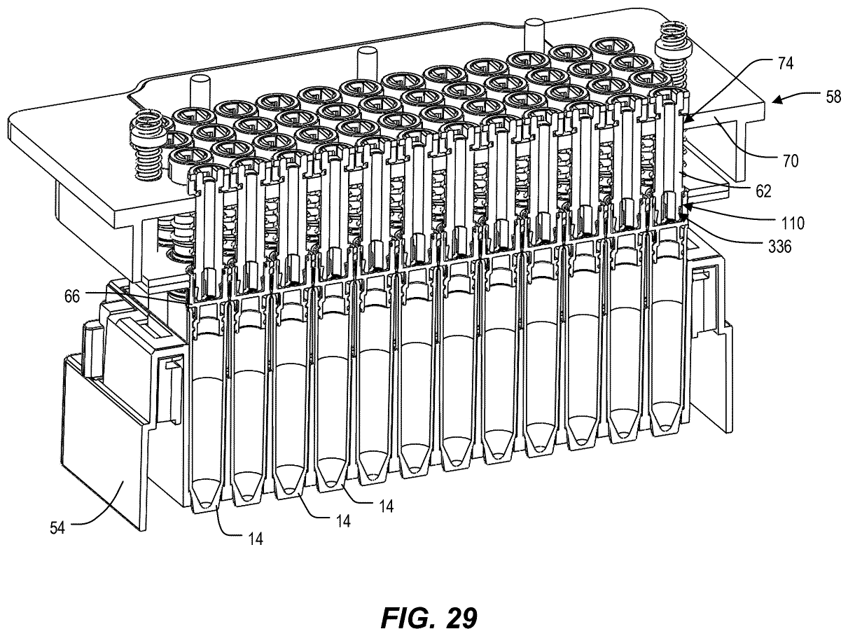

FIG. 29 illustrates the head unit 58 engaged with tubes 14 in the rack 54. FIG. 29 is a cross-sectional view. However, it should be appreciated that the illustrated head unit 58 includes ninety-six (96) cap-drivers 62 and ninety-six (96) tubes 14 are positioned within the rack 54. Each cap-driver 62 is aligned with and engaged with one tube 14 having the first cap 66. The interface end 336 of each cap-driver 62 is entirely inserted into the head cavity 110 of an associated tube 14. In this position or state, rotation of each first cap-driver 62 would cause the associated cap 66 to rotate therewith.

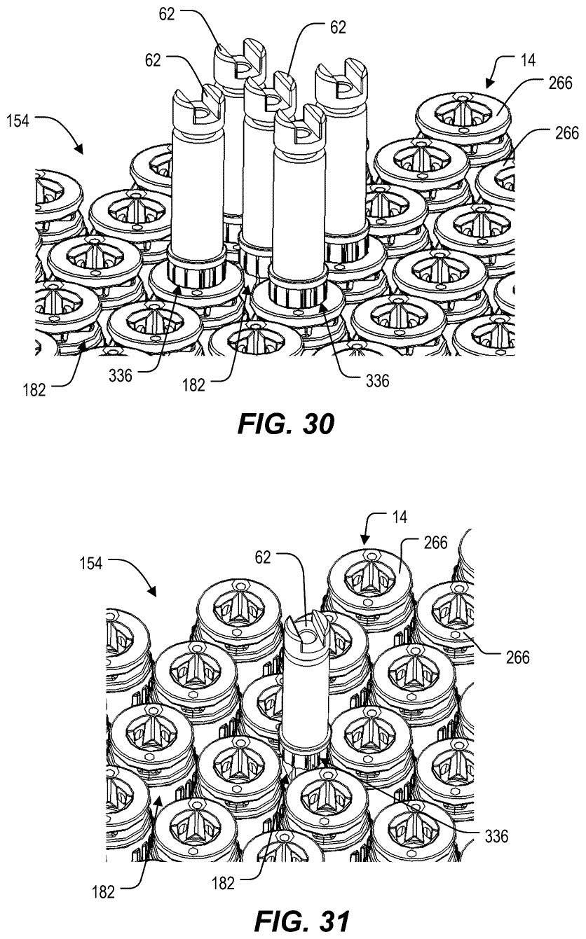

FIGS. 30 and 31 illustrate some cap-drivers 62 of the head unit 58 engaged with some tubes 14 in the rack 154. FIGS. 30 and 31 only illustrate a portion of the rack 154. However, it should be appreciated that the rack 154 includes forty-eight (48) tubes 14 positioned within the rack 154.

With reference to FIG. 30, four cap-drivers 62 are in engagement with associated third caps 266, and one cap-driver 62 is positioned in a gap 182. Each of the five cap-drivers 62 are extended the same length towards the rack 154. The interface end 336 of the cap-driver 62 in the gap 182 is not in contact with any of the adjacent third caps 266. It should be appreciated that if the system 10 was used with a rack having a different number of tubes 14, the cap-drivers 62 that do not engage caps will similarly be positioned in gaps between the tubes 14.

During operation, a user may want to remove the caps 66 from tubes 14. To remove the caps 66 from a set of tubes 14, a user can first load a plurality of tubes 14 into the rack 54. The tubes 14 can be sealed with associated caps 66. The user can power on the system 10. The user can, for example, press a button on the display 42. The user can then prepare the system 10 to receive the rack 54. The user can, for example, press a button on the display 42. The system 10 can then slide the rack-support unit 50 along the track 46 towards the first side 22 of the system 10. The system 10 can then move the shield 34 to the opened position to provide access to the operational area 30. The user can then load the rack 54 onto the rack-support unit 50. The user can then instruct the system 10 to remove the caps 66 from the tubes 14. The user can, for example, press a button on the display 42. The button can specifically instruct the system 10 to remove the caps 66 from the tubes 14. The system 10 can then move the shield 34 to the closed position to close the operational area 30. The head unit 58 can detect characteristics of the tubes 14 or the rack 54 and determine a desired or operational position of the rack 54. In the operational position, each tube 14 in the rack 54 is aligned with a cap-driver in the head unit 58. The system 10 can then slide the rack-support unit 50 and the rack 54 along the track 46 away from the first side 22 and into the operational position. The head unit 58 can detect the cap type of the cap 66. For example, the sensors in the head unit 58 can identify the cap type. The head unit 58 can then move each cap-driver 62 an associated distance based on the identified cap type. For example, if the head unit 58 detects the first cap 66 or any other cap to be engaged by the first interface portion 340 (i.e., the first cap type), the head unit 58 can move the cap-drivers 62 a first depth. At the first depth, each rib 114 is engaged by the first interface portion 340 of a cap-driver 62. If the head unit 58 detects the second cap 166, the third cap 266, or any other cap to be engaged by the second interface portion 344 (i.e., the second cap type), the head unit 58 can move the cap-drivers 62 a second depth. At the second depth, each drive socket 210, 310 is engaged by the second interface portion 344 of a cap-driver 62. The second depth can be less than or smaller than the first depth. Specifically, the difference between the second depth and the first depth can be equal to a height of the first interface portion 340. In this example with the cap 66, the head unit 58 detects the first cap type. As such, the head unit 58 can then move each cap-driver 62 (e.g., ninety-six (96) cap-drivers 62) the first depth toward the rack 54. Since the rack 54 includes ninety-six (96) tubes 14, each cap-driver 62 is moved into engagement with one cap 66. Each interface end 336 is entirely inserted into the respective head cavity 110, such that each rib 114 on the cap 66 is engaged by a corresponding arcuate portion 348 of the cap-driver 62. The cap-drivers 62 can be fully engaged with the caps 66 when each ring 346 engages a corresponding top surface of the head wall 94. The system 10 can then rotate each cap-driver 62 in a first direction. The first direction can be, for example, counterclockwise. Rotation of each cap-driver 62 causes the corresponding cap 66 to rotate therewith. Engagement between the ribs 114 and arcuate portions 348 causes each cap 66 to also rotate in the first direction. Each cap 66 rotates relative to the associated tube 14. Each tube 14 can be prevented from rotating by the anti-rotation features. As such, each cap 66 rotates in the first direction relative to the associated tube 14 to threadably disengage from the tube 14. The cap-drivers 62 are rotated until each cap 66 is separated from each respective tube 14. Each cap 66 is then coupled to the associated cap-driver 62. The head unit 58 can then move each cap-driver 62 (and the associated caps 66) away from the tubes 14. Each cap 66 is suspended by the associated cap-driver 62. The engagement (or interlock) between the caps 66 and cap-drivers 62 is stronger than the force of gravity, which prevents the caps 66 from falling off the cap-drivers 62. The system 10 can then slide the rack-support unit 50 and the rack 54 along the track 46 toward the first side 22. The system 10 can then move the shield 34 to the opened position to provide access to the operational area 30. The user can then remove the rack 54 with the uncapped tubes 14.

To couple the caps 66 back on the tubes 14, the user can, for example, press a button on the display 42. The user can then prepare the system 10 to receive the rack 54. The user can, for example, press a button on the display 42. The system 10 can then slide the rack-support unit 50 along the track 46 towards the first side 22 of the system 10. The system 10 can then move the shield 34 to the opened position to provide access to the operational area 30. The user can then load the rack 54 onto the rack-support unit 50. The user can then instruct the system 10 to remove the caps 66 from the tubes 14. The user can, for example, press a button on the display 42. The button can specifically instruct the system 10 to couple the caps 66 on to the tubes 14. The system 10 can then move the shield 34 to the closed position to close the operational area 30. The head unit 58 can determine a new operational position. The system 10 can then slide the rack-support unit 50 and the rack 54 along the track 46 away from the first side 22 and into the operational position. The head unit 58 can then move each cap-driver 62 and cap 66 coupled to the cap-driver 62 by the first depth toward the respective tube 14. The external threads 122 of each cap 66 are moved into engagement with the internal threads on each respective tube 14. The system 10 can then rotate each cap-driver 62 in a second direction. The second direction can be, for example, clockwise. Rotation of each cap-driver 62 causes the corresponding cap 66 to rotate therewith. Engagement between the ribs 114 and arcuate portions 348 causes each cap 66 to also rotate in the second direction. Each cap 66 rotates relative to the associated tube 14. Each tube 14 can be prevented from rotating by anti-rotation features. As such, each cap 66 rotates relative to the associated tube 14 to threadably engage from the tube 14. The cap-drivers 62 are rotated until each cap 66 is couple to each respective tube 14. The head unit 58 can then move each cap-driver 62 away from the caps 66. The system 10 can then slide the rack-support unit 50 and the rack 54 along the track 46 toward the first side 22. The system 10 can then move the shield 34 to the opened position to provide access to the operational area 30. The user can then remove the rack 54 with the capped tubes 14.

The above capping and de-capping operations were described with the rack 54 including ninety-six (96) tubes 14 and each tube 14 having a first cap 66. It should be appreciated that the capping and de-capping operations are essentially the same with different racks having a different number of tubes 14. For example, with racks having less than ninety-six (96) tubes 14 (e.g., the rack 154 with forty-eight (48) tubes 14), one difference from the capping and de-capping methods described herein are that each cap-driver 62 will not engage a cap 66. Rather, some of the cap-drivers 62 will engage a cap 66, and the remaining cap-drivers 62 will be inserted into a gap 182 between the caps 66. The cap-drivers 62 positioned in the gaps 182 do not engage adjacent caps 66. It should also be appreciated that the capping and de-capping operations are essentially the same with different caps on the tubes 14, with the exception of the movement depth of the cap-drivers 62. For example, with tubes 14 having the first cap 66 or any other cap having an inner surface 102 with ribs 114 (i.e., the first cap type), the cap-drivers 62 can be moved the first depth. At the first depth, each rib 114 is engaged by the first interface portion 340 of a cap-driver 62. With tubes 14 having the second cap 166, the third cap 266, or any other cap having a drive socket 210, 310 (i.e., the second cap type), the cap-drivers 62 can be moved the second depth. At the second depth, each drive socket 210, 310 is engaged by the second interface portion 344 of a cap-driver 62.

It will be apparent to one of ordinary skill in the relevant art that suitable modifications and adaptations to the compositions, formulations, methods, processes, and applications described herein can be made without departing from the scope of any embodiments or aspects thereof. The compositions and methods provided are exemplary and are not intended to limit the scope of any of the specified embodiments. All of the various embodiments, aspects, and options disclosed herein can be combined in any variations or iterations. The scope of the compositions, formulations, methods, and processes described herein include all actual or potential combinations of embodiments, aspects, options, examples, and preferences herein described. The exemplary compositions and formulations described herein may omit any component, substitute any component disclosed herein, or include any component disclosed elsewhere herein. The ratios of the mass of any component of any of the compositions or formulations disclosed herein to the mass of any other component in the formulation or to the total mass of the other components in the formulation are hereby disclosed as if they were expressly disclosed. Should the meaning of any terms in any of the patents or publications incorporated by reference conflict with the meaning of the terms used in this disclosure, the meanings of the terms or phrases in this disclosure are controlling. Furthermore, the foregoing discussion discloses and describes merely exemplary embodiments. All patents and publications cited herein are incorporated by reference herein for the specific teachings thereof.

Various embodiments and aspects of the inventions described herein are summarized by the following clauses:

Clause 1. An automated capping and de-capping system comprising: a rack-support unit operable to support at least two types of a rack, each rack operable to support a plurality of tubes having caps, the caps being a first cap type or a second cap type, the second cap type different than the first cap type; a head unit comprising a plurality of cap-drivers, the cap-drivers including a first interface portion operable to engage with the first cap type and a second interface portion operable to engage with the second cap type; and a drive system for moving the rack-support unit and the head unit relative to each other to facilitate engagement between the cap-drivers and the caps of the tubes to cap or de-cap the tubes.

Clause 2. The system of clause 1, wherein the at least two types of racks include a rack operable to support 96 tubes, a rack operable to support 48 tubes, a rack operable to support 24 tubes, a rack operable to support 12 tubes, and a rack operable to support 6 tubes.

Clause 3. The system of clause 1 or 2, wherein the first interface portion is operable to interlock with the first cap type.

Clause 4. The system of any one of clauses 1-3, wherein the second interface portion is operable to interlock with the second cap type.

Clause 5. The system of any one of clauses 1-4, wherein the first cap type includes an annular wall and a plurality of ribs extending along an inner surface of the annular wall.

Clause 6. The system of any one of clauses 1-5, wherein the second cap type includes a square socket.

Clause 7. The system of any one of clauses 1-6, wherein the caps of the plurality of tubes includes more than two types of caps.

Clause 8. The system of any one of clauses 1-7, wherein the plurality of tubes are spaced along the rack in a grid pattern, a honeycomb pattern, or a diagonal pattern.

Clause 9. The system of any one of clauses 1-8, wherein the plurality of cap-drivers includes 96 cap-drivers.

Clause 10. The system of clause 2, wherein the plurality of cap-drivers includes 96 cap-drivers, and wherein each cap-driver can cap or de-cap each of the plurality of tube cap types placed in the rack, the rack operable to support 6 tubes, the rack operable to support 12 tubes, the rack operable to support 24 tubes, the rack operable to support 48 tubes, or the rack operable to support 96 tubes.

Clause 11. The system of clause 10, wherein each rack includes a plurality of slots, each slot configured to support one tube.

Clause 12. The system of clause 10, wherein each cap-driver can cap or de-cap each of the plurality of tube cap types placed in the rack, the rack operable to support up to 6 tubes, the rack operable to support up to 12 tubes, the rack operable to support up to 24 tubes, the rack operable to support up to 48 tubes, or the rack operable to support up to 96 tubes.

Clause 13. The system of clause 10, wherein when the rack is operable to support 96 tubes, each cap-driver aligns directly above one tube in the rack.

Clause 14. The system of clause 10, wherein when the rack is operable to support 48 tubes, half of the cap-drivers align directly above one tube in the rack.

Clause 15. The system of clause 14, wherein the other half of the cap-drivers align directly with gaps in the rack, the gaps defined between the tubes in the rack.

Clause 16. The system of any one of clauses 1-15, wherein the cap-drivers in the head unit can detect and identity different types of tube caps.

Clause 17. The system of any one of clauses 1-16, wherein the plurality of cap-drivers are housed on a cassette head.

Clause 18. The system of any one of clauses 1-17, wherein engagement between the cap-drivers and the caps of the tubes to cap or de-cap the tubes includes rotation of the cap-drivers and the caps.

Clause 19. An automated capping and de-capping system comprising: a rack-support unit operable to support a first rack operable to support a first plurality of tubes having caps, the caps being a first cap type or a second cap type, the second cap type different than the first cap type, and a second rack operable to support a second plurality of tubes having caps, the caps being the first cap type or the second cap type the second plurality of tubes including less tubes that the first plurality of tubes; a head unit comprising a plurality of cap-drivers, the cap-drivers operable to engage with the first cap type and the second cap type; and a drive system for moving the rack-support unit and the head unit relative to each other to facilitate engagement between the cap-drivers and the caps of the tubes to cap or de-cap the tubes.

Clause 20. The system of clause 19, wherein the first rack is operable to support 96 tubes, 48 tubes, 24 tubes, 12 tubes, or 6 tubes.

Clause 21. The system of clause 19 or 20, wherein the second rack is operable to support 96 tubes, 48 tubes, 24 tubes, 12 tubes, or 6 tubes.

Clause 22. The system of any one of clauses 19-21, wherein the cap-drivers are operable to interlock with the first cap type and the second cap type.

Clause 23. The system of any one of clauses 19-22, wherein the first cap type includes an annular wall and a plurality of ribs extending along an inner surface of the annular wall.

Clause 24. The system of any one of clauses 19-23, wherein the second cap type includes a square socket.

Clause 25. The system of any one of clauses 19-24, wherein the caps of the plurality of tubes includes more than two types of caps.

Clause 26. The system of any one of clauses 19-25, wherein the first plurality of tubes are spaced along the first rack in a grid pattern, a honeycomb pattern, or a diagonal pattern.

Clause 27. The system of any one of clauses 19-26, wherein the second plurality of tubes are spaced along the second rack in a grid pattern, a honeycomb pattern, or a diagonal pattern.

Clause 28. The system of any one of clauses 19-27, wherein the plurality of cap-drivers includes 96 cap-drivers.

Clause 29. The system of any one of clauses 19-28, wherein the cap-drivers in the head unit can detect and identity different types of tube caps.

Clause 30. The system of any one of clauses 19-29, wherein the plurality of cap-drivers are housed on a cassette head.

Clause 31. The system of any one of clauses 19-30, wherein engagement between the cap-drivers and the caps of the first plurality of tubes to cap or de-cap the tubes includes rotation of the cap-drivers and the caps.

Clause 32. The system of any one of clauses 19-31, wherein engagement between the cap-drivers and the caps of the second plurality of tubes to cap or de-cap the tubes includes rotation of the cap-drivers and the caps.

Clause 33. A method of operating an automated capping and de-capping system including a plurality of cap-drivers having a first interface portion and a second interface portion, the method comprising: inserting a first rack with a first plurality of tubes into the system, the first plurality of tubes having first caps, the first caps being a first cap type or a second cap type, the second cap type different than the first cap type; detecting the type of the first caps; moving the cap-drivers a first depth to engage the first interface portions with the first caps in response to detecting the first cap type; moving the cap-drivers a second depth to engage the second interface portions with the first caps in response to detecting the second cap type, the second depth different than the first depth; inserting a second rack with a second plurality of tubes into the system, the second plurality of tubes having a different number of tubes than the first plurality of tubes, the second plurality of tubes having second caps, the second caps being the first cap type or the second cap type; detecting the type of the second caps; moving the cap-drivers the first depth to engage the first interface portions with the second caps in response to detecting the first cap type; and moving the cap-drivers the second depth to engage the second interface portions with the second caps in response to detecting the second cap type.

Clause 34. The method of clause 33, wherein the first rack is operable to support 96 tubes, 48 tubes, 24 tubes, 12 tubes, or 6 tubes.

Clause 35. The method of clause 33 or 34, wherein the second rack is operable to support 96 tubes, 48 tubes, 24 tubes, 12 tubes, or 6 tubes.

Clause 36. The method of any one of clauses 33-35, wherein the first cap type includes an annular wall and a plurality of ribs extending along an inner surface of the annular wall.

Clause 37. The method of any one of clauses 33-36, wherein the second cap type includes a square socket.

Clause 38. The method of any one of clauses 33-37, wherein the caps of the plurality of tubes includes more than two types of caps.

Clause 39. The method of any one of clauses 33-38, wherein the first plurality of tubes are spaced along the first rack in a grid pattern, a honeycomb pattern, or a diagonal pattern.

Clause 40. The method of any one of clauses 33-39, wherein the second plurality of tubes are spaced along the second rack in a grid pattern, a honeycomb pattern, or a diagonal pattern.

Clause 41. The method of any one of clauses 33-40, wherein the plurality of cap-drivers includes 96 cap-drivers.

Clause 42. The method of any one of clauses 33-41, wherein the plurality of cap-drivers are housed on a cassette head.

Clause 43. The method of any one of clauses 33-42, wherein engagement between the cap-drivers and the caps of the first plurality of tubes to cap or de-cap the tubes includes rotation of the cap-drivers and the caps.

Clause 44. The method of any one of clauses 33-43, wherein engagement between the cap-drivers and the caps of the second plurality of tubes to cap or de-cap the tubes includes rotation of the cap-drivers and the caps.

What is claimed is:

1. An automated capping and de-capping system comprising:
a rack-support unit operable to support at least two types of a rack, each rack operable to support a plurality of tubes having caps, the caps being a first cap type or a second cap type, the second cap type different than the first cap type;
a head unit comprising a plurality of cap-drivers, the cap-drivers including a first interface portion operable to engage with the first cap type and a second interface portion operable to engage with the second cap type; and
a drive system for moving the rack-support unit and the head unit relative to each other to facilitate engagement between the cap-drivers and the caps of the tubes to cap or de-cap the tubes.

2. The system of claim 1, wherein the plurality of cap-drivers includes 96 cap-drivers.

3. The system of claim 1, wherein the first interface portion is operable to interlock with the first cap type, and wherein the second interface portion is operable to interlock with the second cap type.

4. The system of claim 1, wherein the first cap type includes an annular wall and a plurality of ribs extending along an inner surface of the annular wall, and wherein the second cap type includes a square socket.

5. The system of claim 1, wherein the caps of the plurality of tubes includes more than two types of caps.

6. The system of claim 1, wherein the plurality of tubes are spaced along the rack in a grid pattern, a honeycomb pattern, or a diagonal pattern.

7. The system of claim 1, wherein the at least two types of racks include a rack operable to support 96 tubes, a rack operable to support 48 tubes, a rack operable to support 24 tubes, a rack operable to support 12 tubes, and a rack operable to support 6 tubes.

8. The system of claim 7, wherein the plurality of cap-drivers includes 96 cap-drivers, and wherein each cap-driver can cap or de-cap each of the plurality of tube cap types placed in the rack, the rack operable to support 6 tubes, the rack operable to support 12 tubes, the rack operable to support 24 tubes, the rack operable to support 48 tubes, or the rack operable to support 96 tubes.

9. The system of claim 8, wherein each rack includes a plurality of slots, each slot configured to support one tube.

10. The system of claim 8, wherein each cap-driver can cap or de-cap each of the plurality of tube cap types placed in the rack, the rack operable to support up to 6 tubes, the rack operable to support up to 12 tubes, the rack operable to support up to 24 tubes, the rack operable to support up to 48 tubes, or the rack operable to support up to 96 tubes.

11. The system of claim 8, wherein when the rack is operable to support 96 tubes, each cap-driver aligns directly above one tube in the rack.

12. The system of claim 8, wherein when the rack is operable to support 48 tubes, half of the cap-drivers align directly above one tube in the rack, and the other half of the cap-drivers align directly with gaps in the rack, the gaps defined between the tubes in the rack.

13. The system of claim 1, wherein the cap-drivers in the head unit can detect and identify different types of tube caps.

14. The system of claim 1, wherein the plurality of cap-drivers are housed on a cassette head.

15. The system of claim 1, wherein engagement between the cap-drivers and the caps of the tubes to cap or de-cap the tubes includes rotation of the cap-drivers and the caps.

16. An automated capping and de-capping system comprising:
a rack-support unit operable to support:
a first rack operable to support a first plurality of tubes having caps, the caps being a first cap type or a second cap type, the second cap type different than the first cap type, and
a second rack operable to support a second plurality of tubes having caps, the caps being the first cap type or the second cap type the second plurality of tubes including less tubes that the first plurality of tubes;
a head unit comprising a plurality of cap-drivers, the cap-drivers operable to engage with the first cap type and the second cap type; and
a drive system for moving the rack-support unit and the head unit relative to each other to facilitate engagement between the cap-drivers and the caps of the tubes to cap or de-cap the tubes.

17. The system of claim 16, wherein the first rack is operable to support 96 tubes, 48 tubes, 24tubes, 12 tubes, or 6 tubes.

18. The system of claim 17, wherein the second rack is operable to support 96 tubes, 48 tubes, 24 tubes, 12 tubes, or 6 tubes.

19. The system of claim 16, wherein the cap-drivers are operable to interlock with the first cap type and the second cap type.

20. The system of claim 16, wherein the first cap type includes an annular wall and a plurality of ribs extending along an inner surface of the annular wall, and wherein the second cap type includes a square socket.
